(19) United States
(12) Patent Application Publication
(10) Pub. No.: US 2016/0048640 A1
(43) Pub. Date: Feb. 18, 2016

(54) PATIENT MANAGEMENT SERVICE METHOD, TREATMENT SERVICE PROVIDING METHOD, AND SERVER NODE AND SERVER APPLIED THERETO

(71) Applicants: SK Telecom Co., Ltd., Seoul (KR); SEOUL NATIONAL UNIVERSITY BUNDANG HOSPITAL, Seongnam-si Gyeonggi-do (KR)

(72) Inventors: Chin Youb CHUNG, Seongnam-si Gyeonggi-do (KR); Rong Min BAEK, Seoul (KR); Hee HWANG, Daejeon (KR); Kee Hyuck LEE, Seongnam-si Gyeonggi-do (KR); Soo Young YOO, Seongnam-si Gyeonggi-do (KR); Jong Hoar YOON, Yongin-si Gyeonggi-do (KR); Chul Hee LEE, Seoul (KR); Soo Beom PARK, Yongin-si Gyeonggi-do (KR); Jeong Wan SEO, Seoul (KR); Chan Ho PARK, Seoul (KR)

(21) Appl. No.: 14/831,757

(22) Filed: Aug. 20, 2015

Related U.S. Application Data
(63) Continuation of application No. PCT/KR2014/001355, filed on Feb. 19, 2014.

(30) Foreign Application Priority Data
Feb. 21, 2013 (KR) 10-2013-0018583
Feb. 21, 2013 (KR) 10-2013-0018584

(51) Int. Cl. G06F 19/00

(52) U.S. Cl. CPC G06F 19/322; G06F 19/328

(57) ABSTRACT

A patient management server node includes: a first authenticating unit to, when an application service request including login information and profile information is received from a user terminal device, perform first authentication by determining whether or not the login information matches object information pre-registered in a patient management service DB; a second authenticating unit to parse the profile information from the application service request, and to perform the second authentication by determining whether or not the parsed profile information matches profile information of the user terminal device pre-registered in the patient management service DB; and a controller to provide an application for guiding each of specialized services for each object, and to issue identification (ID) to the user terminal device when the second authenticating unit approves the second authentication.

### CROSS-REFERENCE TO RELATED APPLICATIONS

The present application is a continuation of International Patent Application No. PCT/KR2014/001355, filed Feb. 19, 2014, which is based upon and claims the benefit of priorities to Korean Patent Application No. 10-2013-0018583, filed on Feb. 21, 2013, and Korean Patent Application No. 10-2013-0018584, filed on Feb. 21, 2013. The disclosures of the above-listed applications are hereby incorporated by reference herein in their entirety.

### TECHNICAL FIELD

The present disclosure relates to a method and an apparatus of issuing an ID to a USIM card of a mobile communication terminal device to enable automatic logging-on process, and a method of settling an ID issuing fee in association with a server of a mobile communication provider.

In addition, the present disclosure relates to a method and an apparatus of providing a treatment service in association with a navigation service.

### BACKGROUND ART

The statements in this section merely provide background information related to the present disclosure and do not necessarily constitute prior art.

According to the evolution of a smart card, various methods for utilizing the smart card have been widely sought. A smart card, chip card, or integrated circuit card (ICC) is any pocket-sized card with embedded integrated circuits. Smart cards provide identity documentation, authentication, data storage, and application processing.

Meanwhile, a variety of online services are provided through communication networks, and most of the online service systems require the user to authenticate his or her membership through the logging-on process.

In particular, when using a specific service including websites through a mobile communication terminal device (hereinafter, referred as to a mobile communication terminal or a terminal), users are required to input an ID and a password (PW) for the membership authentication, and to complete the logging-on process for use of the service.

Since such a logging-on process should be conducted whenever using or entering into the service, the inventor(s) has experienced that it causes a loss of time and users' inconvenience, and it is very vulnerable in terms of the personal information protection and the security strengthening.

Meanwhile, an example of the service that frequently requires the logging-on process is a treatment service with respect to patients in a clinic.

For example, the treatment service includes making a treatment appointment with a doctor, or providing information on the treatment with respect to a patient in the clinic that he or she visits.

However, the inventor(s) has experienced that in the case of a big hospital, even though the treatment appointment is made in advance, it takes a long time to wait for the appointed date. The inventor(s) has experienced that in this case, even on the appointed date, the patient misses the date, so that the patient faces inconvenience to reschedule an appointment and wait for the rescheduled date.

Furthermore, the inventor(s) has experienced that in the case of the big hospital that has subdivided medical departments, it is required to provide a location-based service in which the locations of the patients who move in the big hospital are identified to be used as information.

### SUMMARY

In accordance with the first aspect of the present disclosure, a patient management server node comprises a first authenticating unit, a second authenticating unit and a controller. The first authenticating unit is configured to, when an application service request including login information and profile information is received from a user terminal device, perform first authentication by determining whether or not the login information matches object information pre-registered in a patient management service DB. The second authenticating unit is configured to parse the profile information from the application service request, and perform the second authentication by determining whether or not the parsed profile information matches profile information of the user terminal device pre-registered in the patient management service DB. And the controller is configured to provide an application for guiding each of specialized services for each object, and issue identification (ID) to the user terminal device when the second authenticating unit approves the second authentication.

In accordance with the second aspect of the present disclosure, a communication service server node comprises a controller and a bill-processing unit. The controller is configured to, when an identification (ID) key issue request is received from a user terminal device, determine whether or not the user terminal device is valid, and allow an ID key to be issued to the user terminal device when it is determined that the user terminal device is valid. And the bill-processing unit is configured to, when billing information related to the ID issuing is received from a patient management server node, extract login information and profile information from the received billing information, and renew the billing information for a communication service billing process of the user terminal device, when the extracted login information and the profile information indicate the user terminal.

In accordance with the third aspect of the present disclosure, a method performed by a patient management server node comprises: performing first authentication, when an application service request including login information and profile information is received from a user terminal device, by determining whether or not the login information matches object information pre-registered in a patient management service DB; parsing the profile information from the application service request; performing the second authentication, by determining whether or not the parsed profile information matches the profile information of the user terminal device pre-registered in the patient management service DB; providing an application for guiding each of specialized services for each object; and issuing identification (ID) to the user terminal device when the second authentication is approved.

In accordance with the fourth aspect of the present disclosure, a method performed by a communication service node, comprises: receiving an identification (ID) key issue request from a user terminal device; determining whether or not the user terminal device is valid; issuing an ID key to the user terminal device when it is determined that the user terminal device is valid; and when billing information related to the ID issuing is received from a patient management server node, extracting login information and profile information from the received billing information; and renewing the billing information for a communication service billing process of the user terminal device, when the extracted login information and the profile information indicate the user terminal device.

In accordance with the fifth aspect of the present disclosure, a method performed by a treatment service server, comprises: identifying a user terminal device according to an activation/deactivation reference point that is identified from a navigation service server; and providing a treatment service that is associated with an object obtained from each of a plurality of interworking service servers, based on the record of the identified user terminal device.

### DESCRIPTION OF DRAWINGS

FIG. 1 is a schematic block diagram of an configuration of a patient management system in the wireless short-range network, according to at least one embodiment of the present disclosure;

FIG. 2 is a detailed block diagram of a patient management server node, according to at least one embodiment of the present disclosure;

FIG. 3 is a detailed block diagram of a communication service server node device, according to at least one embodiment of the present disclosure;

FIG. 4 is a flowchart of a patient management service method in a wireless network, according to at least one embodiment of the present disclosure;

FIG. 5 is a flowchart of a patient management service providing method, according to at least one embodiment of the present disclosure;

FIG. 6 is a flowchart of a communication service providing method, according to at least one embodiment of the present disclosure;

FIG. 7 is an configuration of a treatment service providing system in association with a navigation service, according to at least one embodiment of the present disclosure;

FIG. 8 is an example of displaying an application provided in a treatment service providing system in association with a navigation service, according to at least one embodiment of the present disclosure;

FIG. 9 is an example of identifying a user terminal that enters a predetermined area in a treatment service providing system in association with a navigation service, according to at least one embodiment of the present disclosure;

FIG. 10 is the operation and the configuration of a user terminal in a treatment service providing system in association with a navigation service, according to at least one embodiment of the present disclosure;

FIG. 11 is an example of displaying a survey of an application provided in a treatment service providing system in association with a navigation service, according to at least one embodiment of the present disclosure;

FIG. 12 is an example of displaying the treatment-completed state or the treatment-uncompleted state of an application provided in a treatment service providing system in association with a navigation service, according to at least one embodiment of the present disclosure;

FIG. 13 is a flowchart of a treatment service providing method in association with a navigation service, according to at least one embodiment of the present disclosure;

FIG. 14 is a detailed block diagram of a treatment service server device, according to at least one embodiment of the present disclosure;

FIG. 15 is a detailed block diagram of a navigation service server device, according to at least one embodiment of the present disclosure; and

FIG. 16 is a flowchart of a treatment service providing method, according to at least one embodiment of the present disclosure.

### DETAILED DESCRIPTION

Hereinafter, at least one embodiment of the present disclosure will be described in detail with reference to the accompanying drawings. Like reference numerals in the drawings denote like elements. In the following description of the present disclosure, a detailed description of known functions and configurations incorporated herein will be omitted when it makes the subject matter of the present disclosure unclear.

It will be understood that the terms “comprises” and/or “comprising,” or “includes” and/or “including” when used in this specification, specify the presence of stated components, but do not preclude the presence or addition of one or more other components. The term “unit” or “module” specifies a unit performing at least one function or operation and implementable as hardware, software or a combination thereof.

Some embodiments of the present disclosure provide a method and an apparatus of issuing an ID to a mobile communication terminal device adopting a USIM card of the terminal to thereby enable the automatic logging-on process to a treatment service(s), and allowing the settlement of the ID issuing fee in association with a server of the mobile communication provider. In addition, some embodiments of the present disclosure provide a hospital guide and the treatment service(s), which is associated with a navigation service.

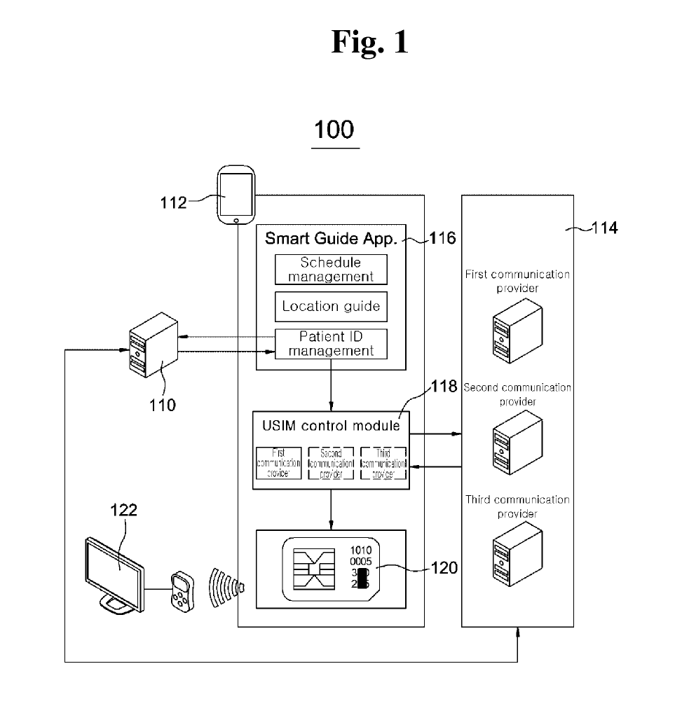

FIG. 1 is a schematic block diagram of an configuration of the patient management service providing system in the wireless network, according to at least one embodiment of the present disclosure.

Referring to FIG. 1, the system 100, to which the present disclosure is applied, includes a patient management server node 110, a user terminal device 112 (hereinafter, referred to as “user terminal”), a communication service server node 114, and an infra-node 122. Herein, a server node or a node is a physical network entity of communication networks. For example, the node or the server node is a connection point, a redistribution point, or a communication endpoint (e.g., some terminal equipment). The physical network node is an active electronic device that is attached to a network, and is capable of creating, receiving, or transmitting information over a communications channel. Each of the patient management server node 110, the user terminal device 112, the communication service server node 114, and the infra-node 122 is implemented by, or includes, one or more processors and/or application-specific integrated circuits (ASICs) specified for respectively corresponding operations and functions described herein in the present disclosure. Each of the patient management server node 110, the user terminal device 112, the communication service server node 114, and the infra-node 122 includes a communication module to transmit signals and to perform communication with various types of devices or wired/wireless communication networks such as the Internet, wireless personal area network (WPAN), wireless local area network (WLAN), WiBro (wireless broadband, aka WiMax) network, mobile communication network and the like or through various communication interfaces such as, for example, an air, a cable, a universal serial bus (USB) and the like.

The patient management server node 110 communicates with a plurality of nodes, provides applications for guiding services that are specialized for each object, and stores and integratedly manages a plurality of events in the network.

More specifically, based on pre-stored information on the patients, which is provided from the electronic medical record (EMR) system of a hospital, the patient management server node 110 broadcasts overall treatment service information of the patients to a plurality of nodes, i.e., the nodes including medical staff/patient terminals, a mobile communication base station, and POS systems distributed in the hospital, through a wireless network established in the hospital, or stores and integratedly manages the events generated in the plurality of nodes in the wireless network to thereby provide information to the connected nodes so that the integrated search for the overall events can be made in real time.

The user terminal 112 adopts tags of Near Field Communication (NFC), Radio-frequency identification (RFID), Bluetooth, Zigbee, or the like to use short-range wireless communication, performs the communication with the patient management server node 110 through the wireless network, defines device identifiers in the operating system, and makes a request to the patient management server node 110 for providing an application service through profile information corresponding to the device identifier. The user terminal includes one or more processors and/or application-specific integrated circuits (ASICs) specified for respectively corresponding operations and functions described herein in the present disclosure. The user terminal (or user equipment) is embodied by, for example, a PC (personal computer), a notebook computer (laptop computer), PDA (personal digital assistant), PMP (portable multimedia player), PSP (PlayStation Portable), a wireless communication terminal device, smart phone, TV and the like.

That is, the user terminal 112 applied to the present disclosure makes a first connection to an EMR server or the patient management server node 110 of a corresponding hospital, and in order to install an application for providing the treatment service, transmits login information and profile information for the registration of membership to the servers to be thereby preregistered. Then the user terminal 112 downloads the application from the servers.

Here, the application, as shown in the drawing, is a smart guide App 116 by which the schedule management for the treatment service for each patient, a guide for the location where the treatment service is made, and a patient ID management service are provided.

Afterwards, the user terminal tries logging on to request service provision of the downloaded application in order to be provided with a user-customized treatment service.

At this time, in order to identify whether or not the user is a preregistered member, the login information and the profile information are transmitted to the patient management server node 110 again.

The profile, which is unique identification information on a corresponding user terminal, includes at least one of an operation parameter defined in the operating system of the terminal, the MAC address of the device, the type of CPU, the resolution of a display, the universal subscriber identity module (USIM), or the international mobile equipment identity (IMEI), and the patient management server node 110 that has received the profile analyzes the corresponding profile to thereby analyze the device features of the user terminal.

Continuously, the communication service server node (the communication service server node of a mobile communication provider to which the user terminal has subscribed) communicates with the patient management server node 110 and the user terminal 112 through the wireless network, and determines the validation (effectiveness) {e.g., the unique number (telephone number) given when subscribing to the mobile communication service} of the user terminal 112 to thereby issue a requested ID key to the identified user terminal 112.

The infra-node 122, which is the same thing as a kiosk, such as a kind of POS system, conducts guiding of a treatment schedule, paying of treatment fees, receiving of the treatment, printing of a prescription/receipt/map, advertising of a hospital, and providing of hospital information, in the hospital, and the infra-nodes are distributed in the wireless network to recognize information corresponding to the ID for each object, which is read through tagging of the user terminal, and to relay data between the patient management server node and the user terminal.

Based on the system configuration mentioned above, when a request for providing the application service for the treatment service is received from the user terminal 112 using each patient terminal, the patient management server node 110 receives the login information and the profile information on the user terminal, and parses the received login information to determine whether or not it matches preregistered object information, and to thereby perform the first authentication.

If the first authentication is approved, the patient management server node 110 parses the received profile information, and determines whether or not it matches the profile information of the user terminal, which has made the initial connection, to thereby perform the second authentication. When the second authentication is approved, the patient management server node issues an ID to the corresponding user terminal.

As described above, in conducting the second authentication, the patient management server node 110 analyzes the parsed profile information to obtain a device identifier of the corresponding user terminal, and calls the login information preregistered when requesting the download of the application for each object and the information that matches the corresponding profile information of the user terminal 112, which has conducted the registration of the login information, to thereby compare the same.

At this time, the user terminal 112 makes a request to the patient management server node 110 for issuing an ID, receives the requested ID that is issued according to the determination result of the suitability (e.g., matching of the preregistered patient login and profile information) by the patient management server node 110, makes a request to the communication service server node 114 corresponding to the mobile communication provider 118, to which the user terminal has subscribed, for an ID key corresponding to the issued ID, and stores the received ID key in the USIM 120.

Afterwards, the patient management server node 110 creates billing information to charge the fee due to the ID issuing to thereby transmit the same to the communication service server node 114 corresponding to the user terminal 112 identified through the login information and the profile information.

In addition, the communication service server node 114 extracts the login information and the profile information from the billing information received from the patient management server node 110, and identifies the authority by the matching between the same and the unique identification information of the user terminal 112, to which the ID key has been issued, to thereby renew the billing information for the communication service billing process.

The infra-node 122 identifies an ID issuing record of the user terminal 112 through the patient management server node 110 so that the ID issuing fee is charged for in the communication service billing process of the communication company that the corresponding user terminal 112 uses.

In addition, the infra-node 122 tags the ID and the ID key, which are stored in the USIM card 120 adopted in the user terminal 112, and receives an ID issuing record based on the tagged ID and ID key from the patient management server node 110.

Meanwhile, the patient management server node 110 identifies the authority to display corresponding information for each object, based on the ID and the ID key of the user terminal 112, which are read from the infra-node 122, and makes a control to retrieve, correct and register the corresponding object information preregistered in the patient management service DB according to the user's interruption created from the infra-node 122.

The user interruption refers to the operation including touching, dragging, and button-inputting by the user according to the user's selection on the display view of the infra-node adopting a touch screen.

Hereinafter, a patient management server node 200, according to at least one embodiment of the present disclosure, will be described.

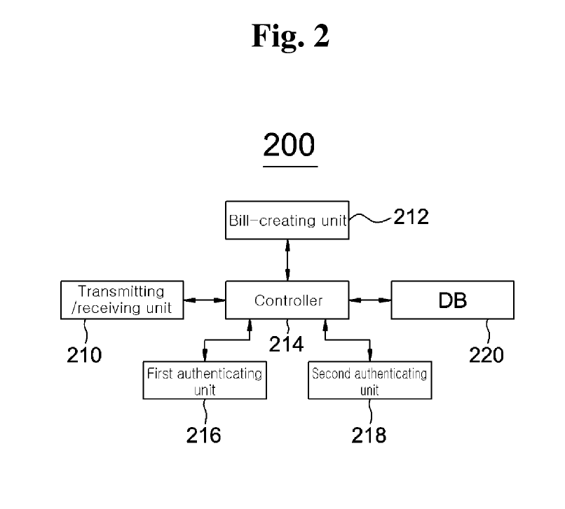

FIG. 2 is a detailed block diagram of a patient management server node 200, according to at least one embodiment of the present disclosure.

Referring to FIG. 2, the patient management server node 200, according to the present disclosure, includes a transmitting/receiving unit 210, a bill-creating unit 212, a controller 214, the first authenticating unit 216, the second authenticating unit 218, and a patient management service DB 220. Each of the transmitting/receiving unit 210, the bill-creating unit 212, the controller 214, the first authenticating unit 216, and the second authenticating unit 218 is implemented by, or includes, one or more processors and/or application-specific integrated circuits (ASICs) specified for respectively corresponding operations and functions described herein. The transmitting/receiving unit 210 includes a communication module to transmit and or receive signals to and from a plurality of nodes.

The first authenticating unit 216 parses the login information received from the user terminal, which requests the application service through its own login information and profile information, and determines whether or not the parsed login information matches the object information preregistered in the patient management service DB to thereby perform the first authentication.

The second authenticating unit 218, in the case where the first authentication is approved by the first authenticating unit 216, parses the profile information, and determines whether or not the parsed profile information matches the profile information of the user terminal, which has made an initial connection, through the patient management service DB 220, to thereby perform the second authentication.

At this time, in performing the second authentication, the second authenticating unit 218 analyzes the parsed profile information to obtain a device identifier of a corresponding user terminal, and calls the login information preregistered in the patient management service DB when requesting the download of the application for each object and information that matches the corresponding profile information of the user terminal 112, which has conducted the registration of the login information, to thereby compare the same.

The controller 214 communicates with a plurality of nodes in the network, provides an application for guiding the service that is specialized for each object, stores and integratedly manages a plurality of events in the network, and issues an ID to a corresponding user terminal when the second authentication is approved by the second authenticating unit 218.

The bill-creating unit 212 creates billing information to charge the ID issuing fee with respect to the communication service server node corresponding to the user terminal identified through the login information and the profile information, under the control of the controller 214.

Hereinafter, a communication service server node 300, according to at least one embodiment of the present disclosure, will be described.

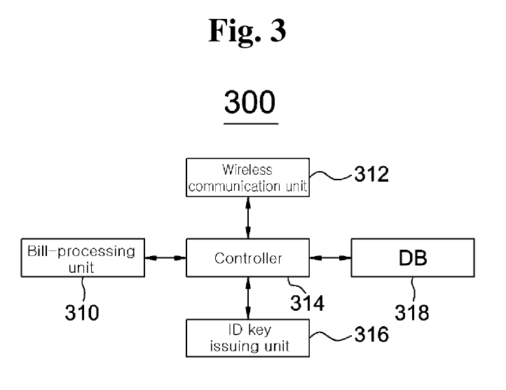

FIG. 3 is a detailed block diagram of a communication service server node 300, according to at least one embodiment of the present disclosure.

Referring to FIG. 3, the communication service server node 300, according to the present disclosure, includes a bill-processing unit 310, a wireless communication unit 312, a controller 314, an ID key issuing unit 316, and a DB 318. Each of the bill-processing unit 310, the wireless communication unit 312, the controller 314, and the ID key issuing unit 316 is implemented by, or includes, one or more processors and/or application-specific integrated circuits (ASICs) specified for respectively corresponding operations and functions described herein. The wireless communication unit 312 includes a communication module to transmit and or receive signals to and from a plurality of nodes.

The controller 314 communicates with the patient management server node and the user terminal in the wireless network through the wireless communication unit 312, and when a request for issuing the ID key is received from the user terminal, determines the validation (effectiveness) of the corresponding user terminal through the USIM to make a control to issue the ID key to the identified user terminal through the ID key issuing unit 316.

The bill-processing unit 310 extracts the login information and the profile information from the billing information on a predetermined user terminal, which is received from the patient management server node, and identifies the authority through the matching between the same and the unique identification information of the user terminal, to which the ID key has been issued by the ID key issuing unit 316, to thereby renew the billing information for the communication service billing process, under the control of the controller 314.

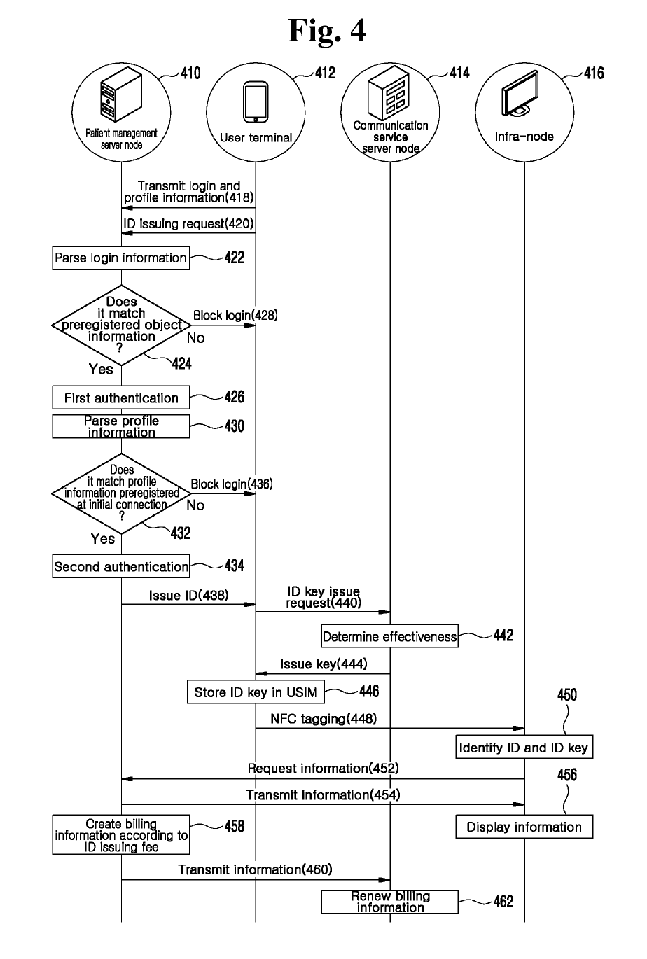

Hereinafter, a patient management service method in the wireless network, according to at least one embodiment of the present disclosure, will be described in detail with reference to FIG. 4.

FIG. 4 is a flowchart of a patient management service method in the wireless network, according to at least one embodiment of the present disclosure.

First, the user terminal 412 transmits the login information and the profile information to the patient management server node 410 in operation 418, and at the same time, requests the issuance of an ID corresponding to the transmitted information in operation 420.

The ID issuing request is for using the treatment service by using the application provided in a corresponding hospital. Prior to operations 418 and 420, the user terminal 412 makes an initial connection to an EMR server or the patient management server node 410 of the corresponding hospital, and in order to install the application for providing the treatment service, transmits the login information and the profile information for the registration of membership to the servers to be thereby preregistered. Then the user terminal downloads the application from the servers.

Here, the application is a smart guide App by which the schedule management for the treatment service for each patient, a guide for the location where the treatment service is made, and a patient ID management service may be provided. The user terminal tries logging on to request service provision of the downloaded application in order to user-customized treatment service in operations 418 and 420.

Next, the patient management server node 410 parses the login information received from the user terminal 412 in operation 422, and determines whether or not the parsed information matches the preregistered object information, i.e., the patient information, in operation 424. If it matches the preregistered object information, the patient management server node 410 proceeds to operation 426 to thereby perform the first authentication, and if it does not match the preregistered object information, proceeds to operation 428 to notify the corresponding user terminal 412 of the block of login.

As described above, when the first authentication is approved, in operation 430, the patient management server node parses the profile information received in operation 418, and determines whether or not the parsed profile information matches the profile information of the user terminal, which has made the initial connection for the download of the application, in operation 432.

As a result of the identification, if the parsed profile information matches the profile information of the user terminal, the patient management server node proceeds to operation 434 to thereby perform the second authentication, whereas if not, the patient management server node notifies the corresponding user terminal 412 of the block of login.

As set forth above, when the first authentication and the second authentication are approved, in operation 438, the patient management server node 210 issues and transmits the ID of the corresponding user terminal 412.

In operation 440, the user terminal 412 makes a request to the communication service server node 414 for the ID key corresponding to the ID issued by the patient management server node 410, and the communication service server node 414, which has received the same, determines the validation (effectiveness) {e.g., the unique number (telephone number) given when subscribing to the mobile communication service} in operation 442 to thereby issue and transmit the ID key to the user terminal 412 in operation 444. For example, The communication service server node 414 compares the phone number received from the user terminal 412 with the phone number issued at the time of subscribing the communication service. The communication service server node 414 determines that the user terminal 412 is valid when the phone number received from the user terminal 412 is same as the phone number issued at the time of subscribing the communication service.

In operation 446, the user terminal 412 stores the ID key issued by the communication service server node 414 in the USIM.

Afterwards, in operation 448, the user terminal 412, which has stored the ID key in the USIM, conducts the tagging with respect to the infra-node 216, and in operation 450, the infra-node 416 identifies the ID and ID key of the tagged user terminal 412.

When the infra-node makes a request to the patient management server node 410 for the patient information, based on the identified ID and ID key in operation 452, the patient management server node 410 identifies the information displaying authority for the corresponding object through the ID and the ID key, and makes a control to display the corresponding object information preregistered in the patient management service DB on the infra-node 416 in operation 456 so that retrieval, correction, and registration thereof can be made according to the user's interruption generated from the infra-node 416.

In operations 458 and 460, the patient management server node 410 creates the billing information to charge the ID issuing fee, and transmits the same to a corresponding communication service server node 414 for the user terminal identified through the login information and the profile information.

In operation 462, the communication service server node 414 extracts the login information and the profile information from the billing information received from the patient management server node 410, and identifies the authority through the matching between the same and the unique identification information of the user terminal 412, to which the ID key has been issued, to thereby renew the billing information for the communication service billing process.

Hereinafter, a patient management service providing method, according to at least one embodiment of the present disclosure, will be described.

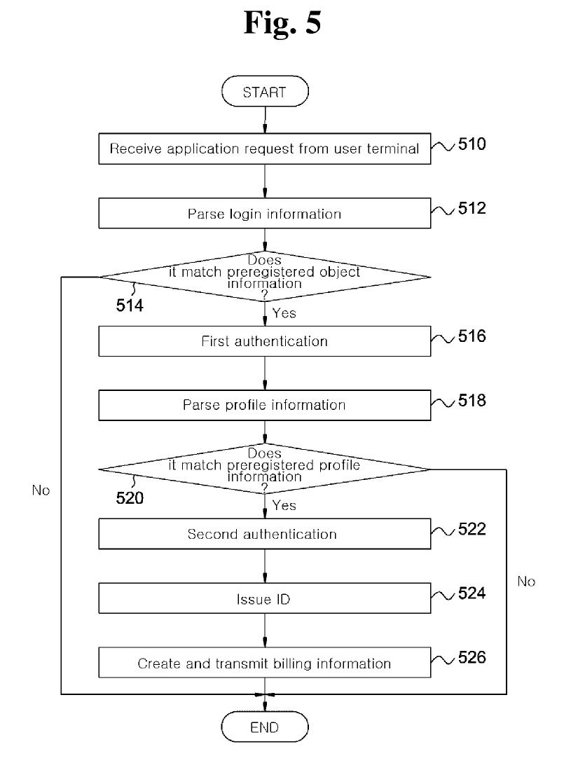

FIG. 5 is a flowchart of a patient management service providing method, according to at least one embodiment of the present disclosure. Referring to FIG. 5, first, in operation 510, the patient management server node receives the request for the application from the user terminal using the login information and the profile information thereof.

The patient management server node parses the login information received from the user terminal in operation 512, and determines whether or not it matches the object information preregistered in the patient management service DB in operation 514. If it matches the preregistered object information, the patient management server node proceeds to operation 516 to thereby perform the first authentication.

As a result of the operation 516, when the first authentication is approved, the patient management server node parses the received profile information in operation 518, and determines whether or not it matches the profile information of the user terminal, which has made the initial connection, in operation 520. If the parsed profile information matches the profile information of the user terminal, the patient management server node proceeds to operation 522 to thereby perform the second authentication.

When the second authentication is approved in operation 522, the patient management server node proceeds to operation 524 to thereby issue the ID of the corresponding user terminal.

Next, in operation 526, the patient management server node creates the billing information to charge the ID issuing fee, and transmits the same to the corresponding communication service server node for the user terminal identified by the login information and the profile information.

Hereinafter, a communication service providing method, according to at least one embodiment of the present disclosure, will be described.

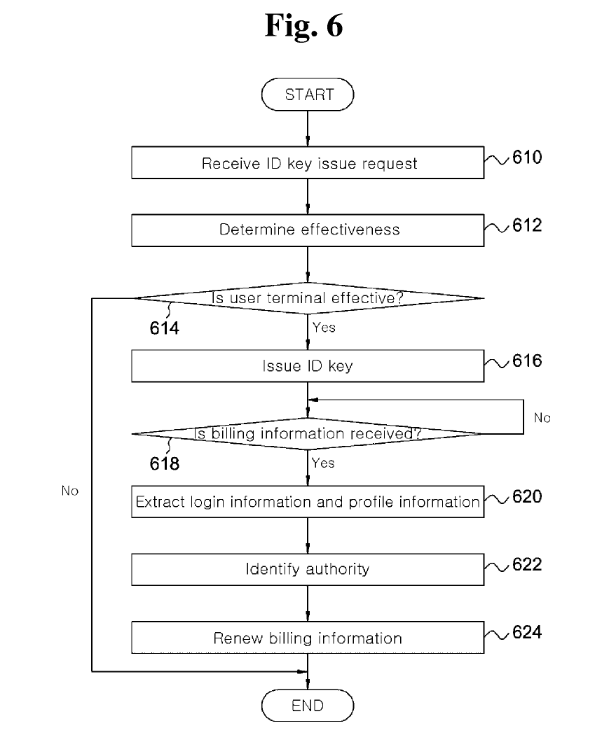

FIG. 6 is a flowchart of a communication service providing method, according to at least one embodiment of the present disclosure. Referring to FIG. 6, first, the communication service server node receives the request for issuing the ID key from the user terminal in operation 610, and determines the validation (effectiveness) through the USIM of the user terminal in operation 612.

As a result of operation 612, the communication service server node checks whether or not the user terminal is valid (effective) in operation 614, and proceeds to operation 616 to thereby issue the ID key to the corresponding user terminal.

In operation 618, the communication service server node checks whether or not the billing information is received from the patient management server node, which interworks with the same through the network, and when the billing information is received as a result of the checking, the communication service server node proceeds to operation 620 to thereby extract the login information and the profile information of the corresponding user terminal.

The communication service server node identifies the authority through the matching with respect to the unique identification information of the user terminal, to which the ID key has been issued, in operation 622, and renews the billing information of the corresponding user terminal for the communication service billing process in operation 624.

The patient management service method in the short-range wireless network including the patient management server node and the communication service server node, and the operation of the system thereof, according to the present disclosure, can be made as set forth above. Meanwhile, although detailed embodiments are disclosed in the description of the present disclosure, various modifications can be made without departing from the scope of the present disclosure. Accordingly, the scope of the present disclosure should be defined according to the appended claims and equivalents thereto rather than the embodiments set forth above.

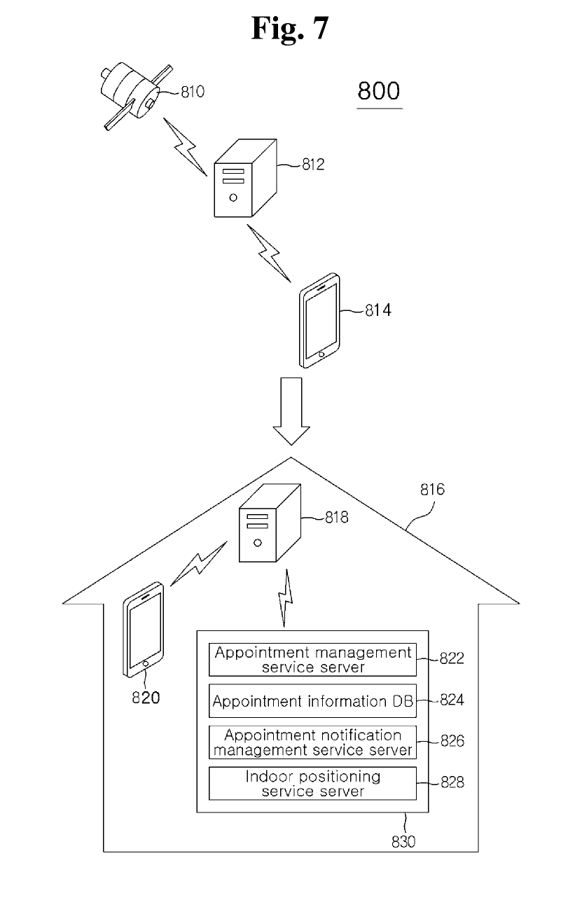

Hereinafter, an configuration of a treatment service providing system associated with a navigation service, according to at least one embodiment of the present disclosure, will be described in detail with reference to FIG. 7.

FIG. 7 illustrates an configuration of a treatment service providing system in association with a navigation service, according to at least one embodiment of the present disclosure.

Referring to FIG. 7, the system 800, to which the present disclosure is applied, includes a GPS 810, a navigation service server 812, a user terminal 814, a treatment service server 818 located in the hospital 816, and a plurality of service servers 830.

The navigation service server 812 identifies a location of the user terminal which is at the indoor place or the outdoor place at the service activation/deactivation reference point predetermined according to the similarity between the log information corresponding to the destination input according to the execution of the navigation service, and the pre-stored log information, and provides the navigation service in association with the treatment service server interworking with the same.

The log information is created for guidance of an actual travel route and traffic information to the destination desired by the user, based on the signals received from the GPS 810 when executing the navigation service, and includes navigation travel time, junction similarity, a travel route, or a travel distance. The navigation service server 812 applied to the present disclosure determines the similarity between the log created when executing the navigation service and the predetermined log information, and if there is similar log information, uses the same to automatically provide the navigation service for the roads that the user passes periodically without an additional operation of configuring the destination.

In addition, with regard to the predetermined service activation/deactivation reference point, it is determined whether the current position is in the outdoor place or in the indoor place, based on the reception or the reception rate of the GPS 810 signal, by analyzing the signal of the GPS 810 associated with the navigation service server 812. In the case of the outdoor place, it matches the activation reference point, and in the case of the indoor place, it matches the deactivation reference point.

With regard to the GPS 810 signals, in the outdoor place, the precise positioning can be made using the GPS radio signals, but when the user enters the indoor place, such as a shopping mall or a specific building, since the GPS signals are not detected, the normal positioning cannot be made. So, the present disclosure determines the user's position as being in the outdoor place or in the indoor place, on the basis mentioned above.

Subsequently, the treatment service server 818 is located in the indoor place 816 where the treatment service is provided, and interworks with a plurality of service servers 830, such as an electronic medical recording service server that makes a DB of medical information on those who provide the treatment service or those who are provided with the treatment service and provides the same, to thereby integratedly manage the objects (patient information) provided from the servers 822, 824, 826 and 828. In addition, the treatment service server 818 identifies the user terminal according to the predetermined service activation/deactivation reference point, and provides the treatment service in association with the objects obtained from the servers 822, 824, 826 and 828 according to the record of the identified user terminal 820.

When a request for a specific treatment service is received from the connected user terminal 820, the treatment service server 818 makes a request to the service server for specific data conforming to the object format that is specialized for each of the associated service servers 822, 824, 826 and 828.

At this time, the plurality of service servers 822, 824, 826 and 828 includes: an appointment management service server 822 that informs the patients of the appointment date for the treatment through the user terminal, and receives the input of the appointment information in order to integratedly notify of the appointment of treatment through the treatment service server; an appointment information database 824 that stores appointment information data; a treatment appointment notification management service server 826 that receives the appointment information data and manages the treatment appointment notification; and an indoor positioning service server 828 that creates position estimation information of the user terminal.

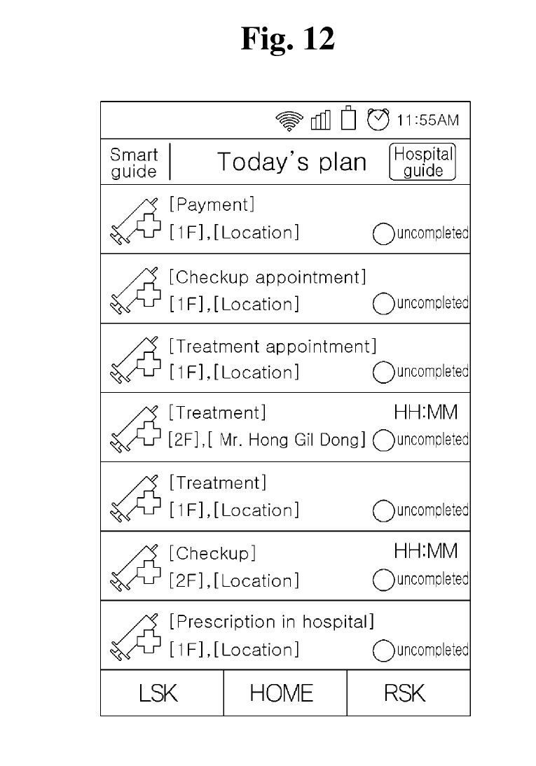

The treatment appointment notification management service server 826 collects the completion or the incompletion of checkups from the electronic medical recording service server in real time to thereby separately display the same in different colors on the divided areas corresponding to an appointed checkup-item time list on a specific appointed date for each patient, as shown in FIG. 12, and makes a control to renew the appointed checkup-item time list to be displayed when an event occurs.

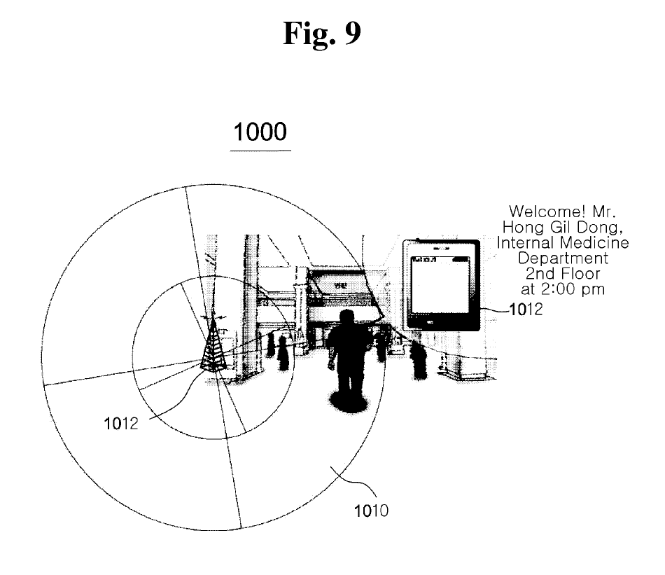

As shown in FIG. 9, when the user terminal 820 enters a predetermined area 1010 based on the mobile communication base station 1012 cell ID, the application for guiding the arrival at the hospital and the location and the time of treatment/checkup is automatically executed on the display unit of the user terminal 1012. The user terminal, which has entered its own cover area, is identified in association with the treatment service server in the predetermined area, and the associated treatment service server is notified of the same.

At this time, the identification of the user terminal 820 is conducted by determining the validation (effectiveness) of the ID through the login information preregistered in the electronic medical recording service server, which interworks with the treatment service server, using a subscriber identification module adopted in the corresponding user terminal.

In addition, the application is provided from the treatment service server 818, and the treatment service allocated to each user is guided through the application.

Meanwhile, when the user terminal 820, which does not have the application installed to guide the service of the treatment service server, enters the cover area 1010 of the base station 1012, a guide for downloading and installing the corresponding application may be displayed through a separate window on the display unit of the user terminal to enable the provision of the service in the corresponding area.

In the present disclosure, when the user terminal 820 enters the indoor place from the outdoor place, the hand-off occurs. Thus, the entry into the cover area of the serving base station may be identified or the predetermined area may be identified, based on the position where the corresponding hand-off occurs. In addition, the entry into the predetermined area in the hospital may be identified according to the reception strength of the GPS radio signal, which is the base for determining the position in the indoor place or in the outdoor place, or the entry into the predetermined area may be identified by detecting the signal transmitted from a short-range communication module adopted in the corresponding user terminal.

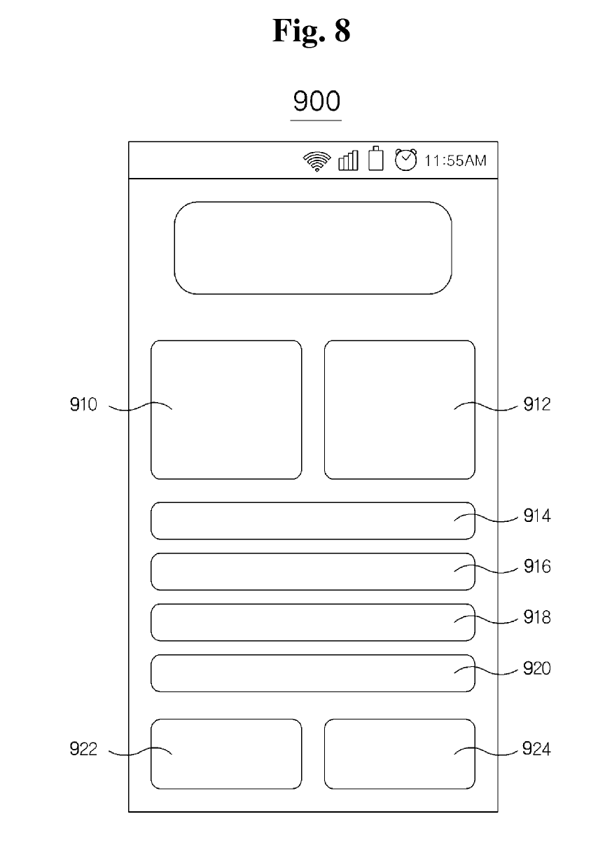

Here, the application provided from the treatment service server 818 will be described with reference to FIG. 8. FIG. 8 illustrates an example of displaying an application provided by the treatment service providing system in association with the navigation service, according to at least one embodiment of the present disclosure. As shown in FIG. 8, the application of the user terminal 820, to which the present disclosure is applied, displays an item list that has a plurality of divided areas 910, 912, 914, 916, 918, and 920, where corresponding items are formed and related pages, which provide services related to the items formed on the divided areas 910, 912, 914, 916, 918 and 920, are linked, so when a corresponding item is selected, the linked page is displayed to thereby provide a predetermined service.

According to at least one embodiment of the present disclosure, the items, such as today's plan, checking of total appointments, retrieval of treatment appointments/treatments, the corresponding hospital, information on the parking lot, a travel route, information on facilities, guide text, or route information, are formed on the divided areas 910, 912, 914, 916, 918 and 920.

For example, in the area of the today's plan, the number of today's appointments for each department is updated to be displayed, and when the user's interruption, i.e., the selection of the corresponding area, occurs, the display image moves on to the today's appointed treatment page.

In addition, in the area of the checking of total appointments, the number of total appointed treatment schedules for each department is updated to be displayed, and when the corresponding area is selected, the display image moves on to the total appointed treatment page.

In addition, a menu for providing the services related to the items for divided areas 910, 912, 914, 916, 918 and 920 is displayed to be preconfigured in an area where the corresponding item is located, and for example, in a predetermined area 918 where the guide text item is formed, the menus of detailed information 920 and route information 922 are display in one area.

When the user's interruption occurs in the area where the menu of the travel route 922 or the information on facilities 924 is displayed, a separate window is created to be displayed.

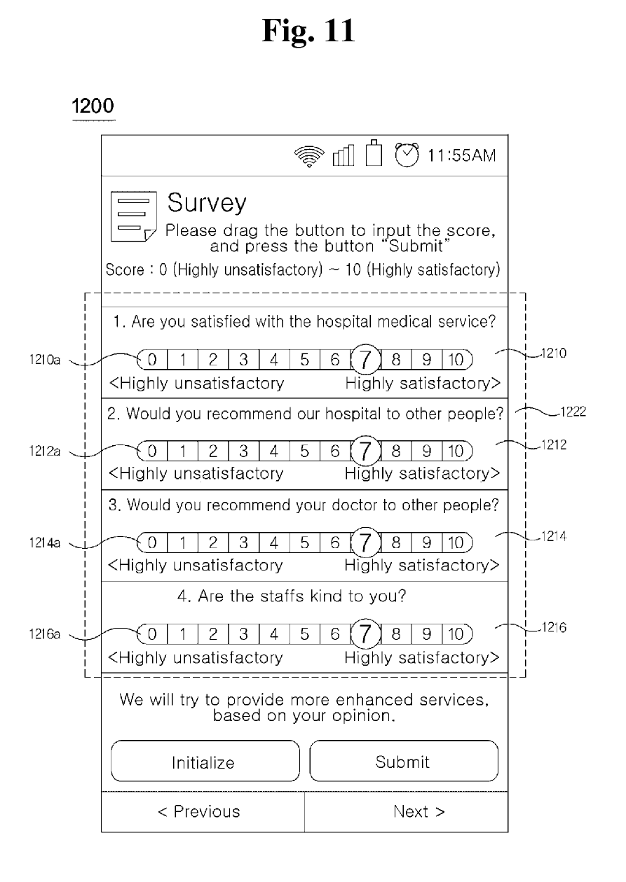

FIG. 11 illustrates an example of displaying a survey of an application provided in the treatment service providing system in association with the navigation service, according to at least one embodiment of the present disclosure. First, Referring to FIG. 11, the main view of the application, to which the present disclosure is applied, displays a survey list 1222 for service items, which receives the user satisfaction through the interruption due to a user's input when providing the treatment service for each user terminal, on divided areas 1210, 1212, 1214, and 1216, and collects the user's interruption with respect to scrollable status bars 1210-a, 1212-b, 1214-c, and 1216-d in the divided areas 1210, 1212, 1214, and 1216 within a predetermined period to thereby calculate and display the satisfaction for the service items.

At this time, the scrollable status bars 1210-a, 1212-b, 1214-c, and 1216-d are to give scores for the user's satisfaction by user's scrolling in one direction along the same on which predetermined numbers are marked in ascending order, or by point-inputting a predetermined number, and at both ends of the area where the scrollable status bars are displayed, a minimum value (e.g., highly unsatisfactory) and a maximum value (e.g., highly satisfactory) with respect to the questions about the user's satisfaction are marked to face each other.

Meanwhile, the application, to which the present disclosure is applied, checks the occurrence of the user's interruption for the divided areas and service items, and if the user's interruption does not occur, a guideline is provided through a pop-up window in order for the user to try the user's interruption due to the input.

Continuously, when a request for route guidance data related to a specific item is received from the user terminal 820, the treatment service server 818 makes a control to provide the route guidance service related to the item selected by the user to the corresponding user terminal through the associated indoor positioning service server 828, using a short-range communication module adopted in the user terminal 820.

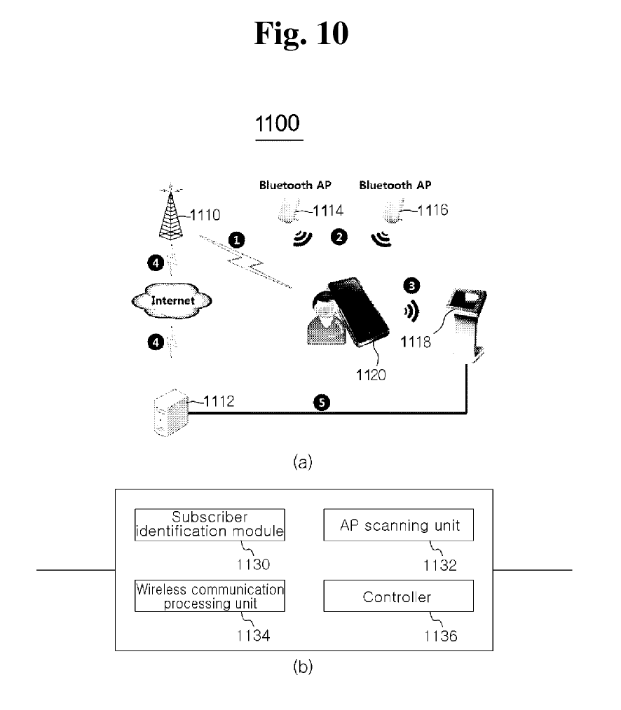

Here, referring to FIG. 10, FIG. 10 illustrates the operation and the configuration of the user terminal in the treatment service providing system in association with the navigation service, according to at least one embodiment of the present disclosure. Although the description is made of Bluetooth-based short-range wireless communication in the embodiment of the present disclosure, it should be noted that the present disclosure is not limited thereto.

First, referring to diagram (a) of FIG. 10, when the user terminal 1120 enters a predetermined area based on the serving base station 1810, it is connected with the treatment service server 1812 through the network, and when the cell ID of the hospital base station is received, the user terminal of the appointed patient automatically invokes the application.

The indoor navigation service provided through the user terminal 1120 allows two or more Bluetooth APs 1814 and 1816 to broadcast their IDs for the short-range wireless communication, i.e., Bluetooth-based, indoor positioning, and calculates the strength of signals received from the Bluetooth APs 1814 and 1816 to thereby display the location on a digital map of the corresponding user terminal using a map indicator.

At this time, the user terminal 1120 adopts the short-range communication module, such as Bluetooth, or near field communication (NFC), and transmits/receives the patient ID and payment information to the treatment service server 1112 or the kiosk 1118.

The kiosk is an infra-node that adopts a reader for tagging through the short-range communication module adopted in the user terminal 1120, that communicates with a plurality of user terminals through the short-range communication module, that is distributed in the area of the predetermined serving base station 1110, that transmits the event received from the user terminal 1120 to the treatment service server 1112 in wireless communication to relay data, or that connects with the treatment service server 1112 through a local area network (LAN) to display a specific event received from the treatment service server 1112.

The main display image of the kiosk 1118 is divided into a patient number input area and a confirmation button area. If the patient number input area is tapped on, a virtual keyboard is displayed in the bottom area, and when the enter-key is pressed after inputting, the focus moves to a window for inputting the resident registration number.

In addition, when the area marked with “confirm” is tapped on, after the completion of the input with respect to the confirmation button area, a login trial window is created to be displayed.

Here, as shown in diagram (b) of FIG. 10, the user terminal 1120 includes a subscriber identification module 1130 that adopts the short-range communication module, an access point (AP) scanning unit 1132 for scanning APs that transmit short-range communication signals all around using the subscriber identification module 1130, a wireless communication processing unit 1134 that receives the short-range communication signals through scanned AP, and a controller 1136 that makes a control to broadcast the ID identified through the subscriber identification module 1130 to one or more APs, and to calculate the strength of the signal from the AP to thereby display a map indicator corresponding to the current location on the map along the movement route in real time.

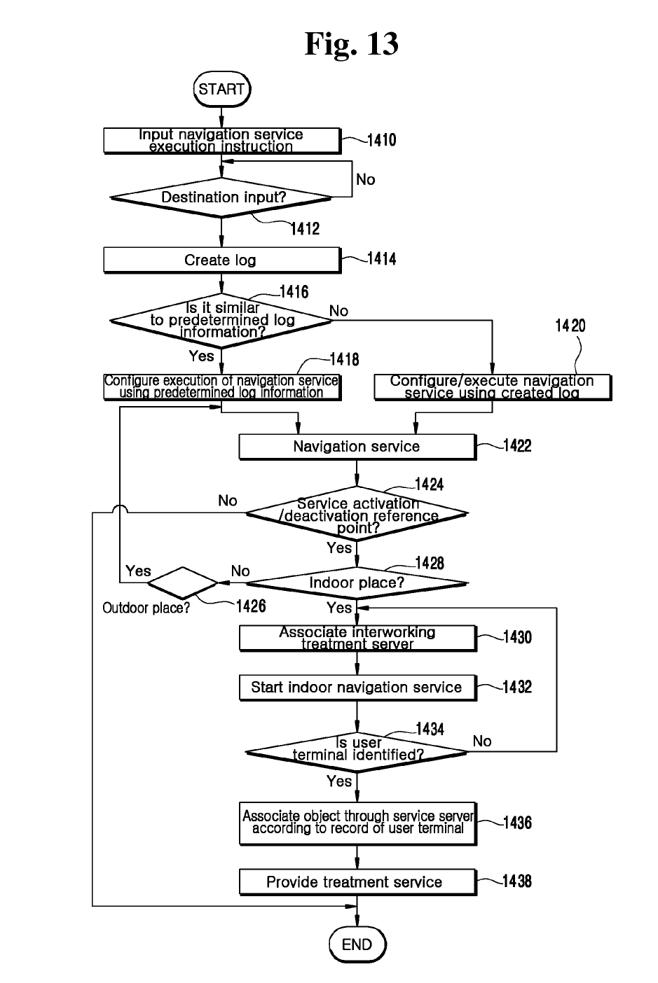

Hereinafter, a method for providing the treatment service in association with the navigation service, according to at least one embodiment of the present disclosure, will be described in detail with reference to FIG. 13.

FIG. 13 is a flowchart of a method for providing the treatment service in association with the navigation service, according to at least one embodiment of the present disclosure.

Referring to FIG. 13, first, in operation 1410, the user inputs the destination through the user terminal according to the execution of the navigation service, and in operation 1414, the navigation service server creates the log corresponding to the destination input according to the execution of the navigation service. In operation 1416, the similarity between the created log and the pre-stored log information is determined.

At this time, the log information is created for a guide for an actual travel route and traffic information to the destination desired by the user, based on the signals received from the GPS when executing the navigation service, and includes navigation travel time, junction similarity, a travel route, or a travel distance.

The navigation service server applied to the present disclosure determines the similarity between the log created when executing the navigation service and the predetermined log information, and if there is similar log information, uses the same to automatically provide the navigation service for the roads that the user passes periodically without an additional operation of configuring the destination.

As a result of the determination in operation 1416, if the log is similar to the pre-stored log information, the navigation service server proceeds to operation 1418 to thereby configure the navigation service to be executed using the pre-stored log information, and if the log is not similar to the pre-stored log information, the navigation service server proceeds to operation 1420 to thereby configure the navigation service to be executed using the log created in operation 1414, and then provide the treatment service in operation 1422.

Next, in operation 1424, the service activation/deactivation reference point is checked. In the case of the service activation/deactivation reference point, it is checked whether the reference point is in the indoor place or in the outdoor place in operations 1426 and 1428, respectively. If the reference point is in the outdoor place, the sequence returns to operation 1422 to continue to perform the navigation service, whereas if reference point is in the indoor place, the sequence proceeds to operation 1430 to thereby continuously perform the navigation service in association with the interworking treatment service server located in the indoor place, and then to start the indoor navigation service.

Here, with regard to the predetermined service activation/deactivation reference point, it is determined whether the current position is in the outdoor place or in the indoor place, based on the reception or the reception rate of the GPS signal, by analyzing the signal of the GPS associated with the navigation service server. In the case of the outdoor place, it matches the activation reference point, and in the case of the indoor place, it matches the deactivation reference point.

With regard to the GPS signals, in the outdoor place, the precise positioning can be made using the GPS radio signals, but when the user enters the indoor place, such as a shopping mall or a specific building, since the GPS signals are not detected, the normal positioning cannot be made. So, the present disclosure determines the user's position as being in the outdoor place or in the indoor place, on the basis mentioned above.

Based on the operation above, the treatment service server interworking with a plurality of service servers identifies the user terminal according to the predetermined service activation/deactivation reference point of the navigation service server in operation 1434, and associates and provides the objects obtained through the service servers according to the record of the identified user terminal to the treatment service server in patient 1436, to then provide the treatment service in operation 1438.

At this time, when entering the predetermined area through the user terminal identification, the application provided from the treatment service server is automatically executed in the user terminal.

In addition, the application displays the item list that has a plurality of divided areas where corresponding items are formed and related pages, which provide services related to the items formed on the divided areas, are linked, so when a corresponding item is selected, the display image moves on to the linked page to thereby provide a predetermined service.

In addition, when a request for route guidance data related to a specific item is received from the user terminal, the treatment service server makes a control to provide the route guidance service related to the item selected by the user to the corresponding user terminal through the interworking indoor positioning service server using the short-range communication module adopted in the user terminal.

The application provided by the treatment service server provides a page where a survey list for service items, which receives the user satisfaction through the interruption due to the user's input when providing the service for each user terminal, is displayed in divided areas, and collects the user's interruption with respect to scrollable status bars in the divided areas within a predetermined period to thereby calculate and display the satisfaction for the service items.

At this time, the scrollable status bars are to give scores for the user's satisfaction by user's scrolling in one direction along the same on which predetermined numbers are marked in ascending order, or by point-inputting a predetermined number, and at both ends of the area where the scrollable status bars are displayed, a minimum value and a maximum value with respect to the questions about the user's satisfaction are marked to face each other.

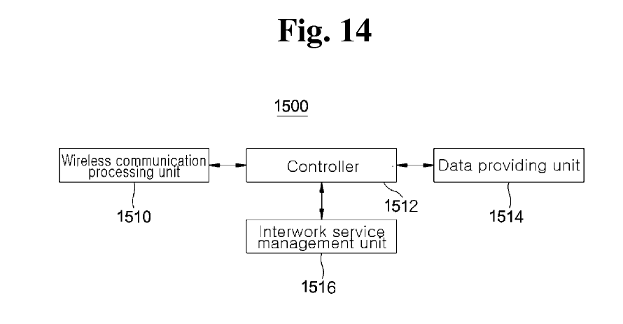

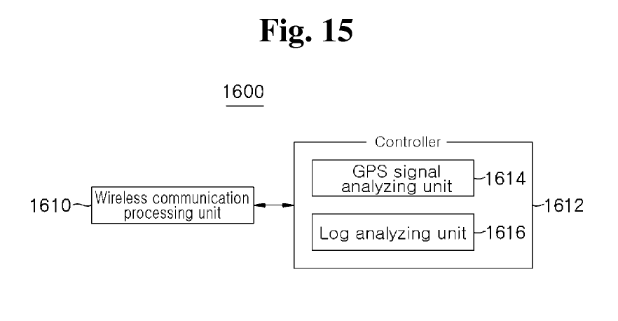

Hereinafter, the treatment service server and the navigation service server, which are included in the treatment service system in association with the navigation service, according to at least one embodiment of the present disclosure, will be described in detail with reference to FIG. 14 and FIG. 15, respectively.

FIG. 14 is a detailed block diagram of a treatment service server 1500, according to at least one embodiment of the present disclosure.

Referring to FIG. 14, a treatment service server 1500 applied to the present disclosure includes a wireless communication processing unit 1510, a data providing unit 1514, and an interwork service management unit 1516. Each of the wireless communication processing unit 1510, the data providing unit 1514, and the interwork service management unit 1516 is implemented by, or includes, one or more processors and/or application-specific integrated circuits (ASICs) specified for respectively corresponding operations and functions described herein. The wireless communication processing unit 1510 includes a communication module to transmit and or receive signals to and from a plurality of nodes.

The wireless communication processing unit 1510 processes the data input through the network to be output, or processes the data received from the controller 1512 to be transmitted in wireless communication.

The interwork service management unit 1516 requests/receives the data with respect to a plurality of service servers and the user terminal, which are connected through the network, and collects/stores the same.

The controller 1512 integratedly manages the objects provided from the service servers in interwork with a plurality of service servers, identifies the user terminal according to the activation/deactivation reference point output from a specific service server, and associates the objects obtained from a plurality of service servers according to the record of the user terminal, which is stored in the interworking service management unit, to thereby provide the service.

In addition, when a request for route guidance data related to a specific item is received from the user terminal, the controller 1512 makes a control to provide the route guidance service related to the item selected by the user to the corresponding user terminal through the indoor positioning service server connected through the network, by using the short-range communication module adopted in the user terminal.

In addition, the controller 1512, using the application provided to the user terminal, provides a page where a survey list for service items, which receives the corresponding user satisfaction through the interruption due to the user's input when providing the service for each user terminal, is displayed in divided areas, and collects the user's interruption with respect to scrollable status bars in the divided areas within a predetermined period to thereby calculate and display the satisfaction for service items.

At this time, the scrollable status bars are to give scores for the user's satisfaction by user's scrolling in one direction along the same on which predetermined numbers are marked in ascending order, or by point-inputting a predetermined number, and at both ends of the area where the scrollable status bars are displayed, a minimum value and a maximum value with respect to the questions about the user's satisfaction are marked to face each other.

In addition, when a request for a specific treatment service is received from the connected user terminal, the controller 1512 makes a request to the service server for specific data conforming to the object format that is specialized for each of the associated service servers.

In addition, when the user terminal is identified, the controller 1512 determines the validation (effectiveness) of the ID through the login information preregistered in the electronic medical recording service server, which interworks therewith, using a subscriber identification module adopted in the corresponding user terminal.

The data providing unit 1514 manages the application provided to the user terminal under the control of the controller 1512.

In addition, the data providing unit 1514, through the application provided to the user terminal, displays a page that has a plurality of divided areas where the item list, in which corresponding items are formed, is displayed, and links the same to related pages, which provide services related to the items formed on the divided areas, so when a corresponding item is selected, the display image moves on to the linked page to thereby provide a predetermined service.

FIG. 15 is a detailed block diagram of a navigation service server 1600, according to at least one embodiment of the present disclosure.

Referring to FIG. 15, the navigation service server 1600, according to at least one embodiment of the present disclosure, includes a wireless communication processing unit 1610, and a controller 1612. Each of the wireless communication processing unit 1610, and the controller 1612 is implemented by, or includes, one or more processors and/or application-specific integrated circuits (ASICs) specified for respectively corresponding operations and functions described herein. The wireless communication processing unit 1610 includes a communication module to transmit and or receive signals to and from a plurality of nodes.

The wireless communication processing unit 1610 processes the data input through the network to be output, or processes the data received from the controller 1512 to be transmitted in wireless communication.

The controller 1612, which includes a GPS signal analyzing unit 1614, and a log analyzing unit 1616, determines whether the current position of the user terminal is in the indoor place or in the outdoor place, based on the reception or the reception rate of the GPS signal of the user terminal, which is in communication, through the GPS signal analyzing unit 1614, identifies a location of the user terminal which is at the indoor place or the outdoor place at the predetermined service activation/deactivation reference point, wherein, in the case of the outdoor place, it matches the activation reference point, and in the case of the indoor place, it matches the deactivation reference point, and provides the navigation service in association with a predetermined interworking service server.

At this time, the controller 1512, using the log analyzing unit 1616, identifies a location of the user terminal which is at the indoor place and the outdoor place at the predetermined activation/deactivation reference point according to similarity between the log corresponding to the destination input when executing the navigation service, and the predetermined log information including navigation travel time, junction similarity, a travel route, or a travel distance.

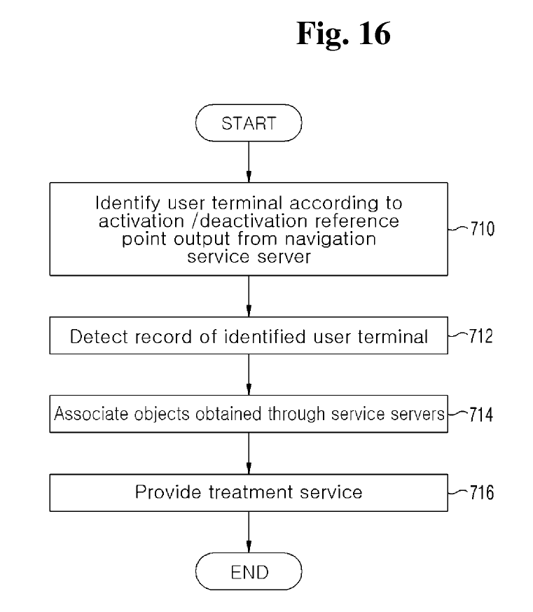

FIG. 16 is an overall flowchart of a method for providing the treatment service, according to at least one embodiment of the present disclosure.

Referring to FIG. 16, first, the treatment service server, which interworks with a plurality of service servers, identifies the user terminal according to the activation/deactivation reference point output from the navigation service server in operation 700, and detects the record of the identified user terminal in operation 712. At this time, the record detection means a type of treatment service that the corresponding user terminal has used. In operation 714, the status information on the corresponding type of treatment service and the occurrence of the event are checked, and the objects managed for each service server, which are specialized in specific services, are associated to thereby provide the treatment service in operation 716.

At this time, the activation/deactivation reference point means a signal output by determining whether the current position is in the outdoor place or in the indoor place, based on the reception or the reception rate of the GPS signal analyzed by the associated navigation service server, wherein, in the case of the outdoor place, it matches the activation reference point, and in the case of the indoor place, it matches the deactivation reference point.

When the user terminal enters the predetermined area, the application provided from the treatment service server is automatically executed. The application performs the operation of displaying an item list that has a plurality of divided areas where corresponding items are formed, linking the same to related pages, which provide services related to the items formed on the divided areas, and moving on to the linked page to thereby provide a predetermined service when the corresponding item is selected.

In addition, when a request for route guidance data related to a specific item is received from the user terminal, the route guidance service related to the item selected by the user is provided to the corresponding user terminal through the indoor positioning service server connected through the network, using the short-range communication module adopted in the user terminal.

The treatment service providing system including the treatment service server, the navigation service server, and the user terminal, and the method thereof, according to the present disclosure, can be made as set forth above. Meanwhile, although detailed embodiments are disclosed in the description of the present disclosure, various modifications can be made without departing from the scope of the present disclosure. Accordingly, the scope of the present disclosure should be defined according to the appended claims and equivalents thereto rather than the embodiments set forth above.

According to various embodiments of a patient management service method of the present disclosure and a server node applied thereto, an ID is issued to a USIM card mounted in the mobile communication terminal to thereby enable the automatic logging-on in using the treatment service, and the ID issuing fee is settled in association with a server of the mobile communication provider, so that stealing or hacking of login information is prevented to safely protect a personal account and to manage the ID issuing fees. In addition, according to various embodiments of a treatment service providing method of the present disclosure, and a server applied thereto, a hospital guide and treatment service, which is associated with the navigation service, is provided to enable a patient-customized service and a medical service with respect to the schedule of treatment/medical checkup to be quickly delivered, as well as to provide a continuous navigation service regardless of the location.

As described above, various embodiments of the present disclosure is implemented by simply modifying a protocol in software without a modification in hardware. Accordingly, some embodiments of the present disclosure are able to be also implemented as computer readable codes on a non-transitory computer readable recording medium. The non-transitory computer readable recording medium is any data storage device that can store data which can be thereafter read by a computer system. Examples of the non-transitory computer readable recording medium include magnetic storage media (e.g., a magnetic tape, a floppy disk, a hard disk, etc.), optical recording media (e.g., a compact disk read only memory (CD-ROM) and a digital video disk (DVD), etc.)), magneto-optical media (e.g., a floptical disk, and hardware devices that are specially configured to store and execute program instructions, such as a ROM, a random access memory (RAM), a flash memory, etc.)

Although exemplary embodiments of the present disclosure have been described for illustrative purposes, those who have ordinary skill in the art will appreciate that various modifications, additions and substitutions are possible, without departing from the spirit and scope of the claimed invention. Specific terms used in this disclosure and drawings are used for illustrative purposes and not to be considered as limitations of the present disclosure. Therefore, exemplary embodiments of the present disclosure have been described for the sake of brevity and clarity. Accordingly, one of ordinary skill would understand the scope of the claimed invention is not limited by the explicitly described above embodiments but by the claims and equivalents thereof.

What is claimed is:

1. A patient management server node comprising:
a first authenticating unit configured to, when an application service request including login information and profile information is received from a user terminal device, perform first authentication by determining whether or not the login information matches object information pre-registered in a patient management service DB;
a second authenticating unit configured to
parse the profile information from the application service request, and
perform the second authentication by determining whether or not the parsed profile information matches profile information of the user terminal device pre-registered in the patient management service DB; and
a controller configured to
provide an application for guiding each of specialized services for each object, and
issue identification (ID) to the user terminal device when the second authenticating unit approves the second authentication.

2. The patient management server node of claim 1, further comprising
a bill-creating unit configured to
create billing information to charge a fee for the ID issuing and
transfer the created billing information to a communication service server node related to the user terminal device that is identified through the login information and the profile information.

3. The patient management server node of claim 1, wherein the second authenticating unit is configured to approve the second authentication when the profile information of the user terminal device, is determined to match the parsed profile information.

4. A communication service server node comprising:
a controller configured to, when an identification (ID) key issue request is received from a user terminal device,
determine whether or not the user terminal device is valid, and
allow an ID key to be issued to the user terminal device when it is determined that the user terminal device is valid; and
a bill-processing unit configured to, when billing information related to the ID issuing is received from a patient management server node,
extract login information and profile information from the received billing information, and
renew the billing information for a communication service billing process of the user terminal device, when the extracted login information and the profile information indicate the user terminal device.

5. A method of operating a patient management server node, the method comprising:
performing first authentication, when an application service request including login information and profile information is received from a user terminal device, by determining whether or not the login information matches object information pre-registered in a patient management service DB;
parsing the profile information from the application service request;
performing the second authentication, by determining whether or not the parsed profile information matches the profile information of the user terminal device pre-registered in the patient management service DB;
providing an application for guiding each of specialized services for each object; and
issuing identification (ID) to the user terminal device when the second authentication is approved.

6. The method of claim 5, further comprising:
creating billing information to charge a fee for issuing the ID; and
transferring the created billing information to a communication service server node related to the user terminal device that is identified through the login information and the profile information.

7. The method of claim 5, wherein, in the performing of the second authentication, the second authentication is approved when the profile information of the user terminal device is determined to match the parsed profile information.

8. A method of operating a treatment service server, the method comprising:
identifying a user terminal device according to an activation/deactivation reference point that is identified from a navigation service server; and
providing a treatment service that is associated with an object obtained from each of a plurality of interworking service servers, based on the record of the identified user terminal device.

9. The method of claim 8, further comprising,
when the user terminal device enters a predetermined area, allowing an application to be executed in the user terminal device,
wherein the application is configured to display a plurality of divided areas, the plurality of divided areas including (i) each item related to the treatment service associated with the object obtained from each of the plurality of service servers, and (ii) each link to a service page related to each item.

10. The method of claim 8, wherein the activation/deactivation reference point is a signal configured to identify whether the user terminal device locates in indoor place or an outdoor place, wherein the identification of the location of the user terminal device are determined based on the reception or a reception rate of a GPS signal, which are analyzed in the navigation service server.
